(19) United States
(12) Patent Application Publication
(10) Pub. No.: US 2025/0030649 A1
(43) Pub. Date: Jan. 23, 2025

(54) STRIDED MESSAGE BASED RECEIVE BUFFER

(71) Applicant: Mellanox Technologies, Ltd., Yokneam (IL)

(72) Inventors: Ortal Ben Moshe, Ein HaEmek (IL); Roee Moyal, Yoqneam Ilit (IL); Shay Aisman, Zichron Ya'acov (IL); Gil Bloch, Zichron Ya'acov (IL); Ariel Shahar, Jerusalem (IL); Roman Nudelman, Kiryat Bialik (IL); Gil Kremer, Hadera (IL); Yossef Itigin, Hod Hasharon (IL); Lior Narkis, Petah Tikva (IL)

(21) Appl. No.: 18/224,258

(22) Filed: Jul. 20, 2023

(51) Int. Cl. H04L 49/9057

(52) U.S. Cl. CPC H04L 49/9057

(57) ABSTRACT

Systems and methods are described herein for processing data packets. An example network adapter may include a network interface operatively coupled to a communication network and packet processing circuitry operatively coupled to the network interface. The packet processing circuitry is configured to receive, via the network interface, a plurality of data packets associated with a message; determine, for each data packet, at least one corresponding reserved stride in a strided buffer; store each data packet in the at least one corresponding reserved stride; process the strided buffer upon storing the plurality of data packets in a corresponding plurality of reserved strides; and generate a completion notification indicating that the plurality of data packets in the strided buffer has been processed.

### TECHNOLOGICAL FIELD

Embodiments of the present disclosure relate generally to data communications, and specifically to devices for interfacing between a computing device and a packet data network.

### BACKGROUND

InfiniBand (IB) is a high-speed interconnect technology commonly used in high-performance computing (HPC) and data center environments. Computing devices (host processors and peripherals) connect to the IB fabric via a network adapter, also known as the host channel adapter. To send and receive messages over the network, the network adapter uses work queue elements (WQEs) posted by a driver program in appropriate work queues (e.g., send queue or receive queue). In IB, the order in which data packets arrive can impact the processing efficiency of the receive operation. Handling out-of-order data packets can be resource-intensive and add latency to the processing. To address these challenges, various techniques have been proposed to optimize the receive queues and work queue elements (WQEs). One such technique involves using strided WQE buffers, where each stride in the strided WQE buffer stores data packets. When a strided WQE is processed, each stride results in the generation of a unique completion queue entry (CQE). This approach can help improve the efficiency of managing out-of-order data packets, but still requires a more complex flow to manage message assembly.

Applicant has identified a number of deficiencies and problems associated with processing data packets in HPC data center environments. Many of these identified problems have been solved by developing solutions that are included in embodiments of the present disclosure, many examples of which are described in detail herein.

### BRIEF SUMMARY

Systems, methods, and computer program products are described for providing a strided message based receive buffer.

In one aspect, a network adapter is presented. The network adapter comprises a network interface operatively coupled to a communication network; packet processing circuitry operatively coupled to the network interface, wherein the packet processing circuitry is configured to: receive, via the network interface, a plurality of data packets associated with a message; determine, for each data packet, at least one corresponding reserved stride in a strided buffer; store each data packet in the at least one corresponding reserved stride; process the strided buffer after storing the plurality of data packets in a corresponding plurality of reserved strides; and generate a completion notification indicating that the plurality of data packets in the strided buffer has been processed.

In some embodiments, the packet processing circuitry is configured to: determine a message sequence number (MSN) for each data packet, wherein the MSN comprises information identifying the corresponding reserved stride in the strided buffer; and store the message in the strided buffer based on the MSN.

In some embodiments, the packet processing circuitry is further configured to: determine an offset associated with each data packet, wherein the offset identifies a position of each data packet in an order of composition of the message; and store each data packet in the at least one corresponding reserved stride based on at least the MSN and the offset.

In some embodiments, processing the message further comprises writing the plurality of data packets from the strided buffer to one or more memory indices associated with a memory.

In some embodiments, the packet processing circuitry is configured to determine the plurality of reserved strides based on at least a maximum message size that is supported by one or more connections across the communication network.

In some embodiments, the strided buffer is a work queue element (WQE).

In another aspect, a method for processing data packets is presented. The method comprises: receiving, via a network interface, a plurality of data packets associated with a message; determining, for each data packet, at least one corresponding reserved stride in a strided buffer; storing each data packet in the at least one corresponding reserved stride; processing the strided buffer after storing the plurality of data packets in a corresponding plurality of reserved strides; and generating a completion notification indicating that the plurality of data packets in the strided buffer has been processed.

In yet another aspect, a network adapter is presented. The network adapter comprises: a network interface operatively coupled to a communication network; packet processing circuitry operatively coupled to the network interface, wherein the packet processing circuitry is configured to: receive, via the network interface, a subset of a plurality of data packets, wherein the subset comprises in-order data packets; aggregate the subset of the plurality of data packets to be stored in a first strided buffer; receive, subsequently, an out-of-order data packet; cause the first strided buffer to be processed in response to receiving the out-of-order data packet; and generate a first completion notification indicating that the subset of the plurality of data packets in the first strided buffer has been processed.

In some embodiments, the out-of-order data packet is associated with the plurality of data packets.

In some embodiments, the packet processing circuitry is configured to: determine whether the plurality of data packets is received within a predetermined time period; determine that only a first subset of the plurality of data packets is received within the predetermined time period; aggregate the first subset of the plurality of data packets to be stored in a second strided buffer; process the second strided buffer; and generate a second completion notification indicating that the first subset of the plurality of data packets in the second strided buffer has been processed.

In yet another aspect, a method for processing data packets is presented. The method comprising: receiving, via a network interface, a subset of a plurality of data packets, wherein the subset comprises in-order data packets; aggregating the subset of the plurality of data packets to be stored in a first strided buffer; receiving, subsequently, an out-of-order data packet; causing the first strided buffer to be processed in response to receiving the out-of-order data packet; and generating a first completion notification indicating that the subset of the plurality of data packets in the first strided buffer has been processed.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made to the accompanying drawings. The components illustrated in the figures may or may not be present in certain embodiments described herein. Some embodiments may include fewer (or more) components than those shown in the figures.

FIG. 1 illustrates an example data communication system, in accordance with an embodiment of the present invention;

FIG. 2 illustrates a strided structure of a work queue element (WQE), in accordance with an embodiment of the invention;

FIG. 3 illustrates a method for processing data packets using a strided buffer, in accordance with an embodiment of the present invention; and

FIG. 4 illustrates a method for processing data packets using data packet aggregation, in accordance with an embodiment of the present invention.

### DETAILED DESCRIPTION

### Overview

Computing devices (host processors and peripherals) connect to the IB fabric via a network adapter, which is referred to in IB parlance as a channel adapter. Host processors (or hosts) use a host channel adapter (HCA), while peripheral devices use a target channel adapter (TCA) to connect to the IB fabric.

Client processes running on a host processor, such as software application processes, communicate with the transport layer of the IB fabric by manipulating a transport service instance, known as a “queue pair” (QP), made up of a send work queue and a receive work queue (often referred to simply as a send queue and a receive queue). To send and receive messages over the network, the network adapter uses work queue elements (WQEs) posted by a driver program (e.g., a user application) in appropriate work queues (e.g., send queues or receive queues). For example, when a message is to be received by the network adapter, the driver program posts a receive descriptor by creating a WQE and then adds the WQE to a receive queue (e.g., a shared receive queue (SRQ)), preparing the network adapter to receive the message. In the receive queue, each WQE may include processing parameters such as a memory descriptor, a pointer to the location in memory where each message is to be scattered, and metadata that may be used in assembling the data packets containing the message. For each WQE that is processed, a completion queue element (CQE) may be generated indicating that the message has been processed according to the processing parameters. Once the CQE is published, the WQE is considered “consumed” and the driver program is expected to repost another WQE into the receive queue to receive another message. In some cases, a single WQE (e.g., a receive WQE) may be used multiple times for receiving/scattering multiple data packets or messages before it is considered “consumed.”

Typically, two types of receive queues are used in IB: (i) cyclic and (ii) link list. Cyclic receive queues are often preferred over link list due to lower memory requirements, better load balancing, and faster message fetch rate. However, cyclic receive queues require the data packets to arrive in-order. If the data packets arrive out-of-order, a WQE may nonetheless be created to receive the data packets. However, without the entire message, the WQE may not be processed successfully to publish a CQE as the message may not yet be complete. As more and more data packets arrive out-of-order, there is a risk that there may not be sufficient WQEs left for in-order data packets, resulting in the in-order data packets being dropped, and thus potentially causing a deadlock. While a link list receive queue to process data packets arriving out-of-order may be used to address any potential deadlock (e.g., by using a predefined threshold for in-order data packets), processing WQEs in a link list receive queue can consume considerable memory, and the production and consumption of these WQEs can add latency in processing of the data packets, as well as consume resources of the host computing device. To address these challenges, strided WQE buffers have been proposed. In current implementations, each stride in the strided WQE buffer is configured to store data packets. When a strided WQE is processed, each stride causes the generation of a unique CQE. As data packets arrive out of order, there is a risk that data packets associated with a particular message may be spread over several WQEs, requiring a complicated flow to manage message assembly.

As such, the present disclosure strikes a balance between the need to manage potential deadlock and improve overall message fetch rate.

For IB implementation, embodiments of the present invention allocate or reserve a contiguous block of memory that is organized into a series of “strides” or steps in a strided buffer (e.g., WQE) to store data packets associated with a message. Each data packet may include a message sequence number (MSN) that identifies specific reserved strides in the strided buffer for storage. The data packet may also include an offset that identifies a position of that data packet in an order of composition of the message. Based on the MSN and the offset, each data packet may be stored in corresponding reserved strides in the strided buffer. Once all the data packets associated with the message is received, and all prior messages have been processed, the message may be transferred from the strided buffer to memory indices in a memory. In response, a completion notification (e.g., a completion report or completion queue element (CQE)) is generated indicating that the message has been received and has been stored in the memory indices. By performing the stride allocation in advance and storing data packets in corresponding reserved strides, the strided buffer may be required to publish only one completion notification per message.

For Large Receive Offload (LRO) implementation, embodiments of the present invention aggregate the data packets associated with a particular message as they are received. In some implementations, when the data packets arrive in order, embodiments of the present invention aggregate the data packets and store them in a strided buffer until the entire message is received. Then, the aggregated data packets may be transferred from the strided buffer to the memory indices. In response, a completion notification or report is generated indicating that the message has been received and has been stored in the memory indices. In some other implementations, when the order of arrival of the data packets is affected, embodiments of the present invention aggregate, in the strided buffer, only the data packets that were received in order to be transferred to the memory indices. In response, a completion notification is generated indicating that only a partial message has been received and that the partial message has been stored in the memory indices. In some cases, embodiments of the present invention may establish a specific time period for all the data packets of a message to be received for aggregation in the strided buffer. In cases where all the data packets of the message do not arrive within the time period, only data packets that arrived within the time period are aggregated in the strided buffer and subsequently transferred to the memory indices. In response, a completion notification is generated indicating that only a partial message has been received within the time period and that the partial message has been transferred to the memory indices. Any remaining data packets (associated with the same message) that arrive outside the time period are aggregated independently in a different strided buffer.

Although the above terminology and some of the embodiments in the description that follows are based on features of the IB architecture and use vocabulary taken from IB specifications, similar mechanisms exist in networks and I/O devices that operate in accordance with other protocols, such as Ethernet and Fiber Channel. The IB terminology and features are used herein by way of example, for the sake of convenience and clarity, and not by way of limitation.

Embodiments of the present invention will now be described more fully hereinafter with reference to the accompanying drawings, in which some, but not all, embodiments are shown. Indeed, the present disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, “operatively coupled” may refer to the functional connection between network components to facilitate the transmission of data packets between the connected components, ensuring that they are transmitted, received, and processed accurately and in a timely manner. This connection may be achieved through direct or indirect means, such as physical wiring, wireless communication, intermediary devices, software-based protocols, and/or the like, and may incorporate mechanisms for handling data packet transmission, including routing, error detection, and flow control. It should also be understood that “operatively coupled,” as used herein, means that the components may be formed integrally with each other, or may be formed separately and coupled together. Furthermore, “operatively coupled” means that the components may be formed directly connected to each other, or connected to each other with one or more components located between the components that are operatively coupled together. Furthermore, “operatively coupled” may mean that the components are detachable from each other, or that they are permanently coupled together. Furthermore, “operatively coupled” may mean that components may be electronically connected and/or in fluid communication with one another.

As used herein, “data,” “content,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein as receiving data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein as sending data to another computing device, it will be appreciated that the data may be sent directly to another computing device or may be sent indirectly via one or more intermediary computing devices, such as, for example, one or more servers, relays, routers, network access points, base stations, hosts, and/or the like.

As used herein, “illustrative,” “exemplary,” and “example” are not provided to convey any qualitative assessment, but instead merely to convey an illustration of an example. Thus, use of any such terms should not be taken to limit the spirit and scope of embodiments of the present invention.

As used herein, “in one embodiment,” “according to one embodiment,” “in some embodiments,” and/or the like generally mean that the particular feature, structure, or characteristic following the phrase may be included in at least one embodiment of the present disclosure and may be included in more than one embodiment of the present disclosure (importantly, such phrases do not necessarily refer to the same embodiment).

### Example Data Communication System

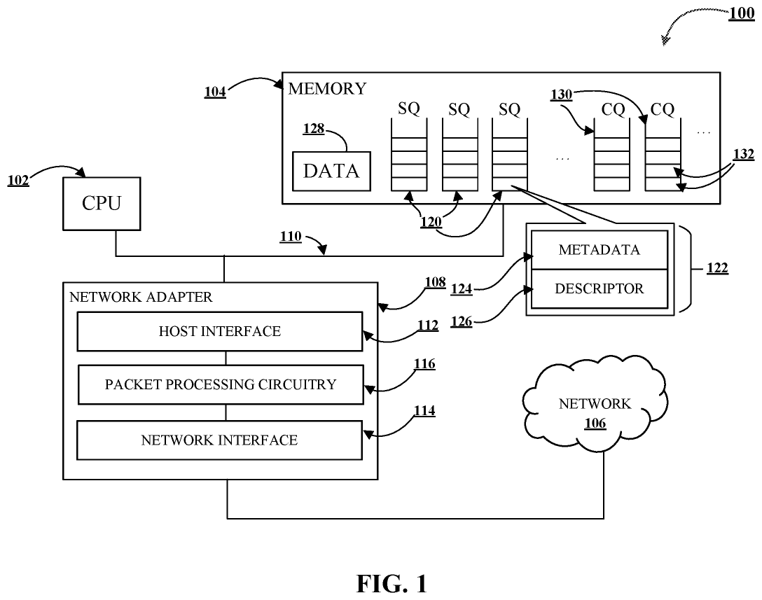

FIG. 1 illustrates a data communication system 100, in accordance with an embodiment of the present invention. As shown in FIG. 1, the data communication system 100 may include a host processor, in the form of a central processing unit (CPU) 102, and a host memory 104 (also referred to as a system memory), which are connected to a suitable bus 110, such as a PCI Express® (PCIe) bus, as is known in the art. CPU 102 may include multiple processing cores (not shown) and may perform the functions described herein under the control of program instructions in software. This software may be downloaded to system 100 in electronic form, over a network, for example. Additionally or alternatively, the software may be stored in tangible, non-transitory computer-readable memory media, such as optical, magnetic, or electronic memory.

A network adapter 108, such as an IB host channel adapter (HCA), may connect the data communication system 100 to a network 106. The network adapter 108 may include a network interface 114 coupled to the network 106, and a host interface 112 coupled to the CPU 102 and memory 104 via a bus 110. Packet processing circuitry 116, coupled between the network interface 114 and the host interface 112, may generate outgoing packets for transmission over the network 106, as described below, and may also process incoming packets received from the network. The host interface 112, the network interface 114, and the packet processing circuitry 116 may typically include dedicated hardware logic, the details of which will be apparent to those skilled in the art after reading the present description. Alternatively or additionally, at least some of the functions of the packet processing circuitry 116 may be implemented in software on a suitable programmable processor.

In some embodiments, client processes running on the CPU 102 may communicate with peers (e.g., a source host) over the network 106 by means of queue pairs (QPs) via the network adapter 108. Each QP may include a send work queue and a receive work queue. To send messages over the network 106 using the network adapter 108, client processes running on the CPU 102, such as processes generated by application software, may submit work requests for execution by the network adapter 108. The work requests may specify a message to be transmitted by means of a pointer to the location of a buffer in a data region 128 of the memory 104. A driver program running on the CPU 102 may process the work requests to generate WQEs 122 and place the WQEs 122 in send queues (SQ) 120 in the memory 104, as shown in FIG. 1. Each WQE 122 may include metadata 124, such as addressing and protocol information, to be used by the network adapter 108 in constructing packet headers and transmitting the corresponding packet or packets. In addition, each WQE 122 may include a descriptor 126 indicating the actual message to be contained in the packet payloads. The descriptor 126 may contain a pointer to the appropriate buffer in the data region 128 of the memory 104. Alternatively, for inline WQEs where the actual message is stored within the WQE 122 itself, the driver program may copy the message from the data region 128 directly into the descriptor 126, so that WQE 122 may include the actual message rather than a pointer to the message. As noted above and described further hereinbelow, the driver program may be able to decide dynamically and automatically, under control of software, when to generate inline WQEs 122 and when to use pointer-based WQEs. To this end, the driver program may set a flag in the WQE 122 (typically a single bit) to indicate whether the data following that bit comprises a pointer or the actual inline data.

In some embodiments, the network adapter 108 may read WQEs 122 from the appropriate queues by means of direct memory access (DMA) transactions on the bus 110, which may be carried out by the host interface 112. The packet processing circuitry 116 may parse the WQEs 122 and, specifically, determine whether each WQE 122 is of the pointer-based or inline type. In the former case, the host interface 112 may perform a further bus transaction to read the message from the location indicated by the pointer in the memory 104. In the latter case, when the WQE 122 is of the inline type, this additional bus transaction may not be required. The packet processing circuitry 116 may then construct one or more packets containing the message and transmit the packets via the network interface 114 to the network 106.

Upon completing execution of a WQE 122, packet processing circuitry 116 may write a completion report, such as a completion queue element (CQE) 132, to a designated completion queue (CQ) 130 in the memory 104. Depending on the reliability requirements of the transport protocol, the packet processing circuitry 116 may write the CQE 132 immediately after sending the message called for by the WQE 122, or it may wait until an acknowledgment has been received from the message destination. Client processes running on the CPU 102 may read the CQEs 132 from their assigned CQs 130 and may thus be able to ascertain that their work requests have been fulfilled.

To receive messages over the network 106 using the network adapter 108, the driver program running on the CPU 102 may prepare for incoming messages by posting receive work requests. These work requests are processed to generate WQEs 122, which are then placed in appropriate receive queues (not shown). Each WQE 122 may include metadata, such as addressing and protocol information, to be used by the network adapter 108 in interpreting packet headers and reassembling the corresponding packet or packets. In addition, each WQE 122 may include a descriptor pointing to the location in memory (e.g., memory indices) where the incoming message is to be stored. When the network adapter 108 detects an incoming message, it may read the WQEs 122 from the receive queue using DMA transactions on the bus 110, which may be carried out by the host interface 112. The packet processing circuitry 116 may parse the received packets and use the information in the WQEs 122 to determine the appropriate location in the data region 128 of the memory 104 for storing the incoming message. If the WQE 122 contains a pointer, the host interface 112 performs a bus transaction to write the incoming message to the location indicated by the pointer in the memory 104. The packet processing circuitry 116 may also generate a CQE 132 indicating that the message has been received and processed according to the parameters specified in the WQE 122.

Once the CQE 132 is published, the WQE 122 is considered “consumed,” and the driver program running on the CPU 102 is expected to repost another WQE 122 into the receive queue to prepare for receiving another message. This ensures that the network adapter 108 is ready to receive and process new incoming messages over the network 106.

### Example Strided Buffer Structure of a WQE

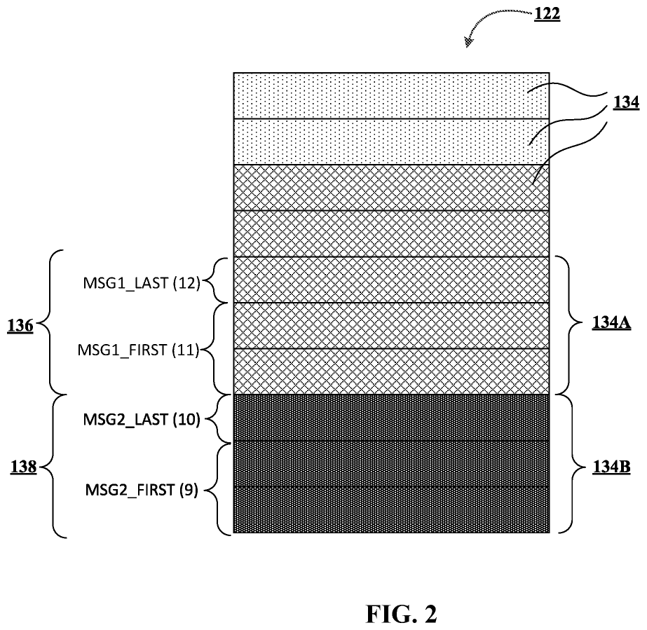

FIG. 2 illustrates a strided buffer structure of a work queue element (WQE) 122, in accordance with an embodiment of the invention. As shown in FIG. 2, the WQE may be a strided buffer comprising a plurality of strides 134. A stride 134 may refer to a segment of memory of a common, fixed size, which may be as small as a single byte or many bytes in length. For example, the size of the stride 134 may advantageously be set to correspond to the expected packet size on a given transport service instance (e.g., equal to or fractionally larger than the expected packet size). As such, the size of the stride may be configurable and can be set to different values based on the connection. The total number of strides 134 may be determined based on at least the maximum message size that can be supported by the transport service instance. As such, in one embodiment, a message with a small payload may consume a single stride, while a message with a large payload may consume multiple strides. In example embodiments, the number of reserved strides for each multi-packet message may be identical. If a multi-packet message does not utilize all of the reserved strides, any leftover reserved strides will remain unused. The plurality of strides 134 may be arranged in the form of contiguous or non-contiguous memory segments in the memory address space, depending on the application. For example, to accommodate a sequence of packets having headers and payloads of fixed, respective size, each stride 134 may comprise a first part that is mapped to one region of memory to receive the headers and a second part that is mapped to another region to receive the payloads.

In an example embodiment, the network adapter 108 may receive a message in the form of a sequence of data packets. As described herein, the data packets may be received out-of-order. Each data packet, however, may include a field, such as a packet offset, that may indicate the position of the data packet within the message. In addition, each data packet may include a message sequence number (MSN) that may identify the reserved strides for the message in the strided buffer (e.g., WQE 122). According to some embodiments, when network adapter 108 detects an incoming message, MSG1 136 or MSG2 138, it reads the WQE 122 from the receive queue using direct memory access (DMA) transactions. Packet processing circuitry 116 may parse the message into data packets and use the MSN to identify specific reserved strides in the WQE 122 for storing the message. In addition, the packet processing circuitry 116 may determine an offset associated with each data packet to identify the position of each data packet in an order of composition of the message. Based on the MSN and the offset, the packet processing circuitry 116 may store each data packet in an appropriate number of the corresponding reserved strides within the contiguous allocation. For example, as shown in FIG. 2, constituent parts of MSG1 136, MSG1_FIRST (11), and MSG1_LAST (12) may be stored in corresponding reserved strides 134A, and constituent parts of MSG2 138, MSG2_FIRST (9) and MSG2_LAST (10) may be stored in corresponding reserved strides 134B. Here, each constituent part may include one or more data packets associated with that message. When the reserved allocation of strides 134 becomes full, or when all data packets of a message have been written to their corresponding strides, the packet processing circuitry 116 may process the WQE 122 by writing the data packets from the strided buffer to one or more memory indices (e.g., data region) in the memory. In response, the packet processing circuitry 116 may generate a CQE indicating that the message has been received and processed according to the parameters specified in the WQE 122. Because a CQE is generated for a complete message rather than for each individual packet, the computational resources required for the CPU to process the CQEs is greatly reduced.

### Example Method for Processing Data Packets Using a Strided Buffer

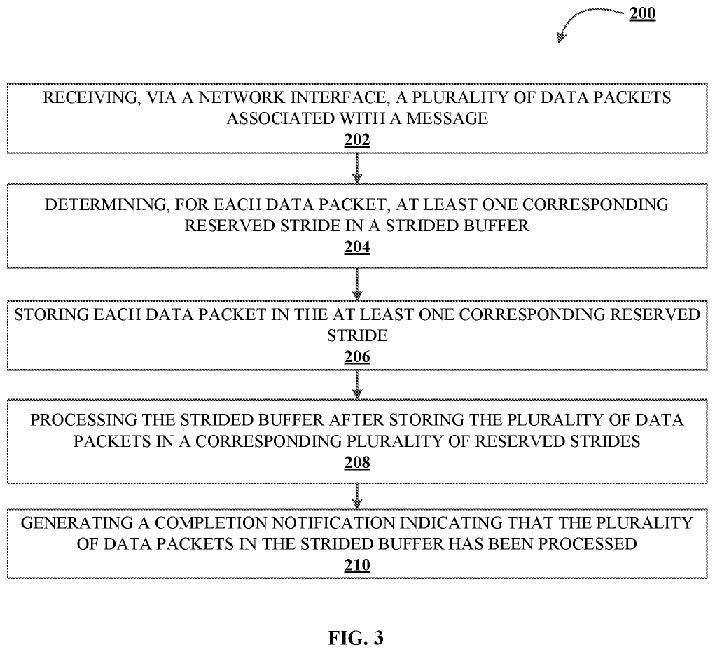

FIG. 3 illustrates a method 200 for processing data packets using a strided buffer structure, in accordance with an embodiment of the present invention. The method 200 may be associated with an IB implementation of the present invention. The method may begin at step 202, in which a network adapter 108 may receive, via a network interface 114, a message comprising a plurality of data packets. The method may then continue to step 204, in which the packet processing circuitry 116 of the network adapter 108 may determine, for each data packet of the message, at least one corresponding reserved stride 134 in a strided buffer. In some embodiments, the strided buffer may be a work queue element (WQE) 122. To determine the corresponding reserved stride for each data packet, the packet processing circuitry 116 may first determine a message sequence number (MSN) for each data packet. The MSN may include information identifying the reserved strides 134 in the WQE 122. For example, the MSN may identify, for a particular data packet, a specific index of a reserved stride 134 within the WQE 122. The packet processing circuitry 116 may also determine an offset associated with each data packet identifying a position of each data packet in an order of composition of the message. The packet processing circuitry 116 may then store the message in the WQE 122 based on the MSN and the offset, as described in greater detail with respect to FIG. 2. In some embodiments, the packet processing circuitry 116 may also determine a total number of strides 134 to be reserved based on a maximum message size that is supported by one or more connections across the communication network 106, as described in greater detail with respect to FIG. 2.

The method may then continue to step 206, in which the packet processing circuitry 116 may store each data packet in the at least one corresponding reserved stride 134 of the WQE 122. The method may then continue to step 208, in which, after storing (or in response to) the data packets, the packet processing circuitry 116 may process the WQE 122. Specifically, the WQE may be processed in response to determining that all of the data packets associated with the incoming message have been received. In some embodiments, processing the data packets may further include writing the data packets from the WQE 122 to the memory indices associated with a memory 104.

The method may then conclude at step 210, in which the packet processing circuitry 116 may generate a completion notification indicating that the plurality of data packets in the WQE 122 has been processed. In some embodiments, the completion notification may be a completion queue element (CQE) 132, and the packet processing circuitry 116 may write the CQE 132 to a designated completion queue 130 in the memory 104. The CQE 132 may indicate that the complete message has been received and has been stored in the memory indices.

### Example Method for Processing Data Packets Using Data Packet Aggregation

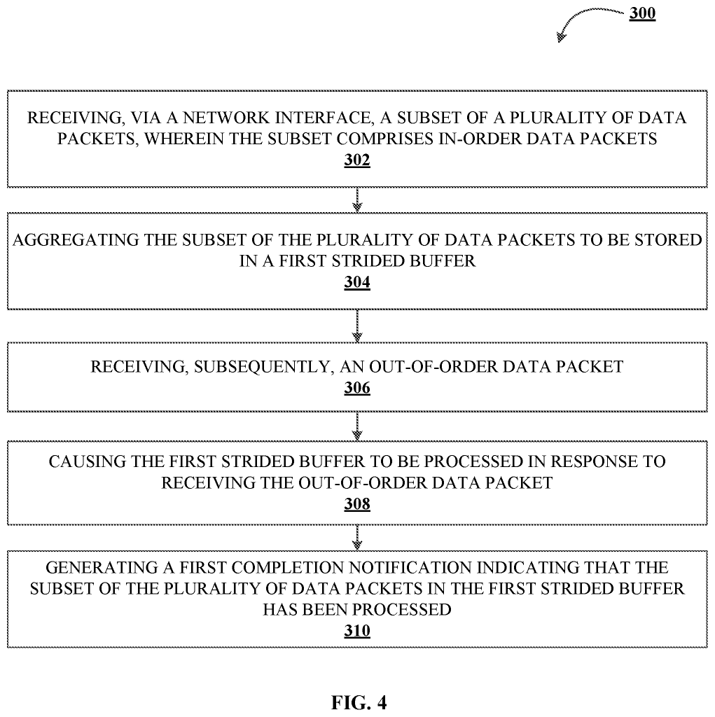

FIG. 4 illustrates a method for processing data packets using data packet aggregation 300, in accordance with an embodiment of the present invention. The method may be associated with a Large Receive Offload (LRO) implementation of the present invention. The method may begin at step 302, in which the network adapter 108 may receive, via the network interface 114, a subset of incoming plurality of data packets. In some embodiments, the packet processing circuitry 116 of the network adapter 108 may determine that the incoming plurality of data packets are in order, i.e., are all packets of the same incoming message and arrive in the same sequence as they were initially sent. If the data packets are in order, the method may then continue to step 304, in which the packet processing circuitry 116 may aggregate the subset of in-order data packets to be stored in a first strided buffer or WQE 122. In some embodiments, in response to determining that all of the data packets associated with the incoming message have been received, the packet processing circuitry 116 may process the first WQE 122 and may write the data packets from the first WQE 122 to the memory indices associated with the memory 104.

Additionally or alternatively, before processing the first WQE 122, the method may continue to step 306, in which the network adapter 108 may receive, via the network interface 114, an out-of-order data packet. The out-of-order data packet may be associated with a second incoming message and/or a second plurality of data packets. In some embodiments, the method may then continue to step 308, in which the packet processing circuitry 116 may cause the first WQE 122 to be processed in response to receiving the out-of-order data packet. The method may then conclude at step 310, in which the packet processing circuitry 116 may generate a first completion notification indicating that the subset of in-order data packets in the first WQE 122 has been processed. In some embodiments, the first completion notification may be a completion queue element (CQE) 132. The method may then repeat at step 304 using the second plurality of data packets, where the second plurality of data packets are aggregated in a second WQE 122 until a data packet associated with a third message is received, triggering processing of the second WQE 122 and the generation of a second CQE 132.

In some embodiments, step 306 may further comprise establishing, via the packet processing circuitry 116, a specific time period (e.g., setting a timer) during which the first WQE 122 is not processed. In said embodiments, if additional data packets associated with the first message are received during the predetermined time period, the packet processing circuitry 116 may write the data packets to the remaining reserved strides of the first WQE 122. However, if the predetermined time period elapses before receipt of additional data packets, the packet processing circuitry 116 may process the first WQE as-is. If additional data packets associated with the first message are received after the predetermined time period, the packet processing circuitry 116 may aggregate the packets into a different WQE 122.

Embodiments of the present disclosure are described below with reference to block diagrams and flowchart illustrations. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

Many modifications and other embodiments of the inventions set forth herein will come to mind to one skilled in the art to which these inventions pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

### INCORPORATION BY REFERENCE

To supplement the present disclosure, this application further incorporates entirely by reference the following commonly assigned patent applications:

| | U.S. Patent | | |
|---|---|---|---|
| Docket | Application | | |
| Number | Ser. No. | Title | Filed On |
| 048833.000144 | To be | SYSTEM AND | Filed |
| | assigned | METHOD FOR LOW | Concurrently |
| | | LATENCY PACKET | Herewith |
| | | PROCESSING | |

That which is claimed:

1. A network adapter, comprising:
a network interface operatively coupled to a communication network;
packet processing circuitry operatively coupled to the network interface, wherein the packet processing circuitry is configured to:
receive, via the network interface, a plurality of data packets associated with a message;
determine, for each data packet, at least one corresponding reserved stride in a strided buffer;
store each data packet in the at least one corresponding reserved stride;
process the strided buffer after storing the plurality of data packets in a corresponding plurality of reserved strides; and
generate a completion notification indicating that the plurality of data packets in the strided buffer has been processed.

2. The network adapter of claim 1, wherein the packet processing circuitry is configured to:
determine a message sequence number (MSN) for each data packet, wherein the MSN comprises information identifying the corresponding reserved stride in the strided buffer; and
store the message in the strided buffer based on the MSN.

3. The network adapter of claim 2, wherein the packet processing circuitry is further configured to:
determine an offset associated with each data packet, wherein the offset identifies a position of each data packet in an order of composition of the message; and
store each data packet in the at least one corresponding reserved stride based on at least the MSN and the offset.

4. The network adapter of claim 1, wherein processing the message further comprises writing the plurality of data packets from the strided buffer to one or more memory indices associated with a memory.

5. The network adapter of claim 1, wherein the packet processing circuitry is configured to determine the plurality of reserved strides based on at least a maximum message size that is supported by one or more connections across the communication network.

6. The network adapter of claim 1, wherein the strided buffer is a work queue element (WQE).

7. A method for processing data packets, the method comprising:
receiving, via a network interface, a plurality of data packets associated with a message;
determining, for each data packet, at least one corresponding reserved stride in a strided buffer;
storing each data packet in the at least one corresponding reserved stride;
processing the strided buffer after storing the plurality of data packets in a corresponding plurality of reserved strides; and
generating a completion notification indicating that the plurality of data packets in the strided buffer has been processed.

8. The method of claim 7, wherein the method further comprises:
determining a message sequence number (MSN) for each data packet, wherein the MSN comprises information identifying the corresponding reserved stride in the strided buffer; and
store the message in the strided buffer based on the MSN.

9. The method of claim 8, wherein the method further comprises:
determining an offset associated with each data packet, wherein the offset identifies a position of each data packet in an order of composition of the message; and
storing each data packet in the at least one corresponding reserved stride based on at least the MSN and the offset.

10. The method of claim 7, wherein the method further comprises:
writing the plurality of data packets from the strided buffer to one or more memory indices associated with a memory.

11. The method of claim 7, wherein the method further comprises:
determining the plurality of reserved strides based on at least a maximum message size that is supported by one or more connections across a communication network.

12. The method of claim 7, wherein the strided buffer is a work queue element (WQE).

13. A network adapter, comprising:
a network interface operatively coupled to a communication network;
packet processing circuitry operatively coupled to the network interface, wherein the packet processing circuitry is configured to:
receive, via the network interface, a subset of a plurality of data packets, wherein the subset comprises in-order data packets;
aggregate the subset of the plurality of data packets to be stored in a first strided buffer;
receive, subsequently, an out-of-order data packet;
cause the first strided buffer to be processed in response to receiving the out-of-order data packet; and
generate a first completion notification indicating that the subset of the plurality of data packets in the first strided buffer has been processed.

14. The network adapter of claim 13, wherein the out-of-order data packet is associated with the plurality of data packets.

15. The network adapter of claim 13, wherein the packet processing circuitry is configured to:
determine whether the plurality of data packets is received within a predetermined time period;
determine that only a first subset of the plurality of data packets is received within the predetermined time period;
aggregate the first subset of the plurality of data packets to be stored in a second strided buffer;
process the second strided buffer; and
generate a second completion notification indicating that the first subset of the plurality of data packets in the second strided buffer has been processed.

16. A method for processing data packets, the method comprising:
receiving, via a network interface, a subset of a plurality of data packets, wherein the subset comprises in-order data packets;
aggregating the subset of the plurality of data packets to be stored in a first strided buffer;
receiving, subsequently, an out-of-order data packet;
causing the first strided buffer to be processed in response to receiving the out-of-order data packet; and
generating a first completion notification indicating that the subset of the plurality of data packets in the first strided buffer has been processed.

17. The method of claim 16, wherein the out-of-order data packet is associated with the plurality of data packets.

18. The method of claim 16, wherein the method further comprises:
determining whether the plurality of data packets is received within a predetermined time period;
determining that only a first subset of the plurality of data packets is received within the predetermined time period;
aggregating the first subset of the plurality of data packets to be stored in a second strided buffer;
processing the second strided buffer; and
generating a second completion notification indicating that the first subset of the plurality of data packets in the second strided buffer has been processed.
